(19) United States
(12) Patent Application Publication
(10) Pub. No.: US 2003/0137375 A1
(43) Pub. Date: Jul. 24, 2003

(54) Magnet assembly attachment for an oil filter

(76) Inventor: William J. Brunsting, Lake Havasu City, AZ (US)

Correspondence Address: WILLIAM BRUNSTING, 3181 DOUGLAS DR., LAKE HAVASU CITY, AZ, 86404, US

(21) Appl. No.: 10/055,257

(22) Filed: Jan. 22, 2002

(51) Int. Cl. H01H 9/00

(52) U.S. Cl. 335/207

(57) ABSTRACT

A magnetic attachment for the exterior wall of an oil filter canister whose purpose is to attract ferrous particles being conducted through the path of the lubricating oil passing through the oil filter canister and cause such to be adhered to the inner wall surface of the sidewall of the oil filter canister thereby removing the particles from the lubricating oil flow path. The attachment has an enclosing frame within which is mounted a series of thin walled plates. The plates are located in a stacked relationship. The plates permit flexing of the enclosing frame so that a plurality of magnets that are mounted in conjunction with the frame will always be located flush against the exterior wall surface of canisters that vary slightly in diameter. The peripheral edge of the attachment is to include ferrous material to prevent lateral escape of the magnetic field.

### BACKGROUND OF THE INVENTION

1. Field of the Invention

The present invention generally relates to an adjustable attachment assembly for removing submicron to micron sized ferrous particles from moving liquids and in particular, is concerned with a series of magnets located on an oil filter canister usable within a closed system of lubricating oil with the series of magnets to be mounted on the exterior surface of the oil filter which results in a magnetic force attracting and holding ferrous particles entrained within the oil against the inside surface of the oil filter preventing circulation of these particles within the closed system and thereby within the engine to which the closed system connects preventing these particles from causing damage to the parts of the engine.

2. Description of the Related Art

Tribology is the science and technology concerned with interacting surfaces and relative motion. Tribology deals with friction, lubrication, wear and erosion. Tribologists have focused their efforts in discovering the root cause of engine and machine failures and to the development of systems and techniques to managing in the most cost effective manner the maintenance of internal combustion engines in order to maximize operational time versus down time. To substantially minimize down time and significantly enhance and make the profitability of businesses and the survival of whole industries. Some field of usage for tribology would be any machine that uses an internal combustion engine, such as automobiles, trucks, robotics, boats, aircraft, earth moving equipment, air compressors and generators. While it has been discovered that particles, moisture, soot, heat, air, glycol, fuel, detergents and processed fluids are all contaminants commonly found in industrial lubricants and hydraulic fluids, it is the particle contamination that is widely recognized as the most destructive to the oil in the engine or machine. A particle counter in conjunction with engines is becoming an important instrument in conjunction with operation of the engine.

The destructive mechanism set in motion by particle contamination of oil is known as the “wear chain”. The wear chain begins with particles of steel, too small to see, and even though most metal-to-metal contact in an engine is prevented by the lubrication system, there is still some contact at the molecular, microscopic level. Metal-to-metal contact at this extremely delicate level is the mechanism by which small particles of steel are torn and gouged from the metal surfaces and introduced into the engine's oil lubricating system. In engines, high local stress associated with sliding contact result in abrasive removal of material surfaces. When loads are concentrated on the effective area of a small particle, the resulting surface stresses can be greater than five hundred thousand psi, far beyond the elastic limit of substrate materials. Oil film thicknesses, between which particles can reach and attack surfaces, are typically in the ten micron range. This explains why, according to a wear study by Cummins Engine, particles smaller than ten microns generated three and one-half times more wear on rods, rings and main bearings than particles greater than ten microns.

The lubrication system of the internal combustion engine is designed to provide a film of oil a mere thousandth of an inch thick on which the engines moving components glide in much the same way that a water skier glides over water. Some areas of the engine, such as the main bearing, rod bearings and valve train use part of the engine's power to pump oil to these areas to provide a thicker film and therefore more protection. The main bearing and rod bearings are even designed to capture a pool of oil that under the pressure supplied by the oil pump, prevents the bearing surface from coming into contact resisting even the high force levels of maximum engine output. However, some areas, such as the timing chain, cylinder walls and piston rings rely on oil splashing from the sump to provide lubrication. The areas relying on the splashing are most prone to generating microscopic particulates of steel that are carried throughout the engine by the lubricating system. The oil film is extremely thin at these metal-to-metal interfaces allowing the microscopic size particles to gouge and act as an abrasive, removing the material from these surfaces. The process produces, small, two to five micron, hardened steel particles that cause the most wear damage to an engine.

The reason that these small steel particles cause so much damage is two fold. First, and most important, such are able to flow into all areas of the engine, including the timing chain, valve train, main bearing and rod bearings and between the rings and cylinder wall. Second, these small particles generate additional particles to produce proportionately more engine wear.

Oil contaminated with these fine particles of steel is abrasive. The sharp, hardened steel particles flow rapidly over the soft bearing surfaces, gouging and cutting along the way. The present invention generally relates to an adjustable attachment assembly for removing submicron to micron sized ferrous particles from moving liquids and in particular, is concerned with a series of magnets located on an oil filter canister usable within a closed system of lubricating oil with the series of magnets to be mounted on the exterior surface of the oil filter which results in a magnetic force attracting and holding ferrous particles entrained within the oil against the inside surface of the oil filter preventing circulation of these particles within the closed system and thereby within the engine to which the closed system connects.

Internal combustion engines generally include a canister shaped oil filter that filter the engine's lubricating oil to remove foreign matter therefrom. To eliminate the particles of foreign matter, the engine oil is typically forced through the porous material in the oil filter that is intended to allow the liquid oil to pass through but does not allow the passage of particles. In this manner, particles of foreign matter are intended to be removed from the engine's lubricating oil. The particles are created by the frictional contact between the moving metal parts of the engine. These particles are actually chards of metal from the metal parts of the engine that are dislodged during operation of the engine. These metallic particles can damage important engine components as such circulate through the engine. Some of these chards of metal are of large size (greater than twenty microns and can be as great as one-quarter of an inch in diameter). These large sized chards of metal have sharp edges. Movement of these chards of metal by the force of the flow of the oil will cause the particles to “slice” like a knife through the filter producing holes greater than the twenty microns thereby decreasing the filter effectiveness of the oil filter. Also, these chards of metal are continuing to be recirculated to come into contact with the engine components causing damage.

Additionally, there may be literally millions of small metallic particles in a single engine that have a cross-sectional dimension smaller than the openings in the porous filter material which means that the oil filter is ineffective in removing of these particles. When not removed by the oil filter, these small metallic particles will freely circulate through the engine until such are finally removed when the oil is changed. Typically, the porous material in oil filters consists of a fibrous material that has openings with an average diameter greater than twenty microns. It is these microns and submicrons sized particles that are the major cause of wear of the moving components of the engine. The metallic particles as such get trapped between moving components of the engine causes metal to bear against metal with the result that damage occurs to between these engine part interfaces. This damage results in a degradation of the close tolerances between the moving parts causing a loss in operating efficiency, loss of horsepower and will eventually result in more frequent maintenance in the form of a repair. By some estimates, these micron and submicron size metallic particles are the cause of more than one. half of the wear on the engine.

In the past, there have been approaches within the prior art to use magnets to remove these metallic particles. One approach is to install a magnetized drain plug in the crankcase of the engine. The intent is for the magnetized drain plug to generate a magnetic field around the magnet within the crankcase which in turn attracts and removes some of the metallic particles from the lubricating oils that flow through the crankcase. However, when the engine is running, the flow rate of oil through the crankcase carries the metallic particles entirely through the magnetic field produced by the magnetized drain plug. In other words, the magnetic field is insufficient in strength to attract and remove a meaningful number of ferrous particles from the lubricating oil.

Another prior art approach is to attach a magnet to the oil filter canister intending to create a magnetic field within the filter to attract and hold the ferrous particles against the walls of the filter in the same manner of the present invention. Unfortunately, many prior attempts did not generate a sufficiently strong magnetic field to attract and hold any significant number of metallic particles which results in these metallic particles continuing to circulate through the engine.

The present inventor has obtained U.S. Pat. Nos. 5,556,540, 5,714,063 and 5,932,108 on improved devices to be mounted on the exterior surface of an oil filter for removing of metallic particles within the oil passing through the filter. Although these devices are known to work at a much improved level of operation, these devices have deficiencies. One deficiency has to do with the flux band that supports the magnets. The flux band is a necessary component for efficient operation in that it confines (concentrates) and directs the magnetic field in a particular direction in patents '540 and '063 with this magnetic field to be able to penetrate the wall of the canister of the oil filter some distance into the flow path of the oil passing through the canister. In the apparatus of '108, the flex band functions just to confine the magnetic energy. There are numerous oil filters that vary slightly in size from the same manufacturer as well as very slightly in size from different manufacturers. It is important, within the structure of the present invention, that the attachment be pressed tightly into contact with the exterior surface of the oil filter. It is hoped to not have to design a unit for every different diameter of oil filter. Therefore, it is intended to have the flux band to be designed to be adjustable so that a particular model of the present invention could be utilized on a plurality of different oil filter diameters. The present inventor has, at the present time, pending U.S. patent application Ser. No. 09/817,467, filed Mar. 26, 2001 in which an adjustable flux band is shown and described. That particular flux band is constructed of a plurality of plates with these plates being located in a stacked arrangement. Rather than making the flux band in one solid piece, the flux band is made of a plurality of thin plates which permit the flux band to bend or flex a limited amount which is sufficient so that a model of the present invention can bend sufficiently to be attachable to a group of oil filters which vary as much as one-half inch (or more) in diameter.

### SUMMARY OF THE INVENTION

The primary objective of the present invention is to construct an attachment that includes an assembly of magnets that is to be mounted on an exterior surface of an oil filter canister where the attachment can be adjustable to accommodate to different diameters of oil filters so that the interior surface of the attachment will be pressed against the exterior surface of the oil filter canister which will result in extraction and holding of ferrous particles, entrained in the oil, to the inside surface of the canister.

The structure of the present invention comprises an attachment that utilizes a plurality of bar magnets which are located in an arcuate row in a spaced side-by-side arrangement. An enclosing housing constructed of non-magnetizable material, such as plastic, is mounted about the magnets and functions to hold the magnets in their established positions. A flux band is mounted directly adjacent the back side of the magnets with the flux band being constructed of a plurality of low carbon steel plates. The thin plates of steel are located in the configuration of an arc with this arc being a segment of a circle. The material of construction of the housing will preferably comprise nylon or plastic with the structure of the housing and the plates of steel of the flux band permitting adjustability of the attachment set to expand to a slightly greater diameter or capable of being moved to a slightly greater diameter. The result is, although the attachment is manufactured for a specific diameter of oil canister, the attachment can adjust to an increased diameter and also to a smaller diameter, and in each instance, the surface of the magnets will be maintained flush against the exterior surface of the oil filter canister. The magnetic field of the magnets is confined by the flux band. To further assist in this confining of the magnetic field, it is desirable to have the magnetic field prevented from escaping through the peripheral edge of the housing. Therefore, this peripheral edge of the housing is to include ferrous material with this ferrous material also providing for adjustability. The ferrous material can comprise wire or rods, a plurality of elongated strips, shot composed of a ferrous composition or the impregnating of small ferrous particles within the injected molded plastic housing.

In extreme vibration environments, such as in conjunction with boats racing, aircraft, off-road vehicles and military vehicle applications, the magnetic force of the magnet may prove to be insufficient to hold the attachment onto the canister. As a safety precaution, the housing of the attachment can be manufactured to include structure that facilitates a precise location connection with a separate securing band. The securing band is to then be tightened about the canister oil filter which secures in position the attachment to the oil filter canister.

### BRIEF DESCRIPTION OF THE DRAWINGS

For a better understanding of the present invention, reference is to be made to the accompanying drawings. It is to be understood that the present invention is not limited to the precise arrangement shown in the drawings.

FIG. 1 is an isometric view of the front face of the magnetic filter attachment of the present invention depicting such being mounted on a cylindrical oil filter canister, which is shown in phantom lines;

FIG. 2 is a longitudinal cross-sectional view through the magnetic filter attachment of the present invention taken along line 2-2 of FIG. 1 showing a first embodiment of attachment;

FIG. 3 is a transverse cross-sectional view through the magnetic filter attachment of the present invention taken along line 3-3 of FIG. 1 showing ferrous material incorporated within the peripheral side edge of the first embodiment of attachment;

FIG. 4 is an isometric view taken in the direction of the front face of the magnetic filter attachment of the present invention of FIG. 3;

FIG. 5 is a cross-sectional view similar to FIG. 3 but of a second embodiment of ferrous material that is incorporated within the peripheral edge of the housing of the assembly of the present invention;

FIG. 6 is an isometric view of the front face of the attachment shown in FIG. 5 of the present invention;

FIG. 7 is a cross-sectional view similar to FIG. 3 but of a third embodiment of ferrous material incorporated in conjunction with the peripheral side edge of the housing of the magnetic filter attachment of the present invention;

FIG. 8 is an isometric view in the direction toward the front face of the third embodiment of FIG. 7 with the housing being shown in phantom lines;

FIG. 9 is a cross-sectional view similar to FIG. 3 but of a fourth embodiment of magnetic filter attachment of the present invention;

FIG. 10 is an isometric view in the direction of the front face of the magnetic filter attachment of the present invention showing only the housing of the filter attachment;

FIG. 11 is an external side view of a modified form of housing for the magnetic filter attachment of this invention showing such connected with a securing band; and

FIG. 12 is an isometric view of the securing band.

### DETAILED DESCRIPTION OF THE INVENTION

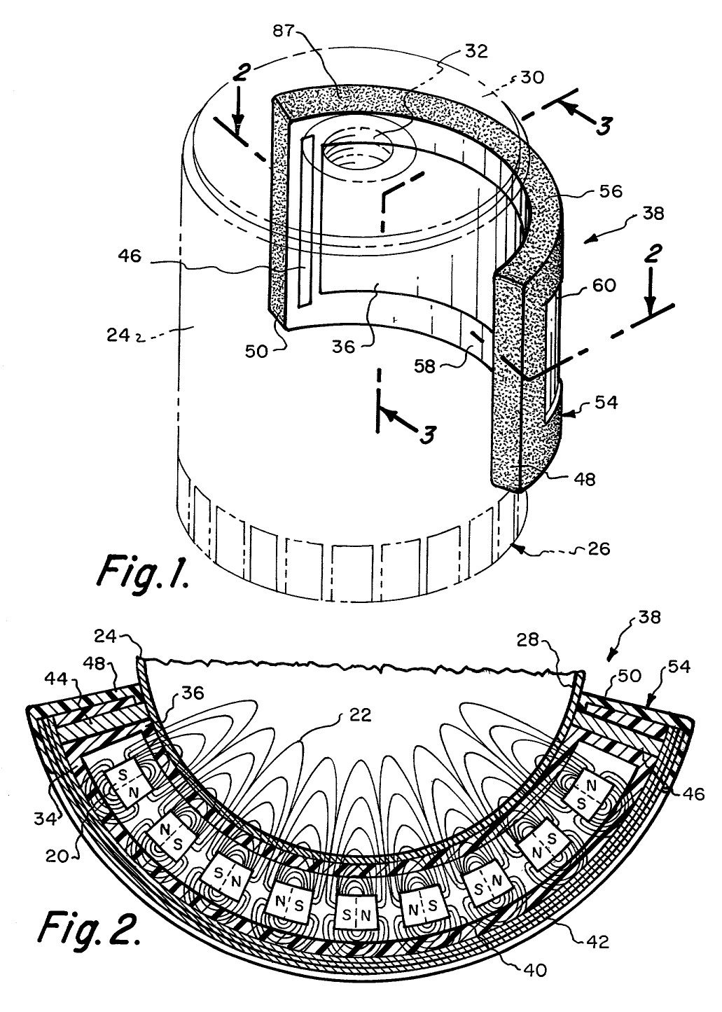

Incorporated within each of the embodiments of the present invention there will be utilized a series of magnets 20 that are arranged in an arcuate row. The magnets 20 are to be incorporated in conjunction with each of the attachments of the present invention. Each of the magnets 20 are shaped basically as bar stock which basically has a rectangular shape in transverse cross-section and also a rectangular shape in longitudinal cross-section. In referring particularly to FIG. 2, it can be seen that there are nine in number of the magnets 20 with each of the magnets 20 being identical. However, it is considered to be within the scope of this invention the magnets 20 need not be identical. The magnets 20 could be of any particular type. However, a desirable type would be a magnet that is constructed of fully dense, sintered, neodymium iron boron. Typically, the magnets will have an intensity of between 15 mg.Oe to 45 mg.Oe. The magnets 20 are located in a side-by-side arrangement and it is noticed that the magnets 20 are spaced slightly apart but could be in physical contact. It is also to be noticed that between each directly adjacent pair of magnets 20 the north poles are abutting and the south poles are abutting. This is what is called a bucking pole arrangement. This bucking pole arrangement produces a deep magnetic field 22 and allows the magnetic field 22 to penetrate radially inward through the sidewall 24 of an oil filter canister 26 and deep into the oil flow path. This penetration by the magnetic field 22 is so that the magnetic field 22 will be able to attract and pull as many as possible of micron and submicron sized particles within the liquid, usually oil, that is caused to flow through the internal chamber 28 of the canister 26. These micron and submicron particles are to be retained against the inside wall surface of the sidewall 24. The magnetic field 22 extends outwardly from the front face of each attachment.

The like poles of the adjacent poles 20 produce magnetic flux lines which will not cross one another due to the fact that such are of like polarity. The interacting energy fields produced by the magnets 20 cause a repulsion of the magnets 20 one from another which, when the magnets 20 are held in place, force the competing lines of flux to move at right angles to the sides or poles of the magnets to complete the magnetic circuits. As a result, the magnetic circuit for each magnet 20 is self contained. In other words, the magnetic circuit for a specific magnet 20 begins and originates on the opposing poles or sides of that magnet 20 and does not cross the flux lines of the adjacent magnet 20. The magnets 20 are located close to one another but spaced therefrom and their repelling fields combined within the confined space of the attachment to intensify the magnetic field 22 to be directed at a right angle to the poles of each of the magnets 20. In this way, the magnetic field 22 is of higher intensity and is sufficiently strong to attract and retain any metallic particle that enters the magnetic field 22 that is circulating within the oil contained within the internal chamber 28.

It is important to confine and direct the magnetic flux producing the magnetic field 22 without short circuiting the magnetic flux path. Therefore, according to this invention, a path of least reluctance is designed into the circuit to combine and direct the magnetic energy and yield a high efficient magnetic member. As a result, the magnets 20, according to this invention, are held slightly away from the sidewall 24 of the filter canister 26 in order to direct the majority of the flux producing the field 22 toward the facing poles of the adjacent magnets and not directly into the filter canister or through the inner surface of the magnets 20. Thus, much of the magnetic energy is forced at right angles to the sides of the magnets 20 and then into the canister wall between the adjacent magnets and from that point is required to reach the region inside the filter in which the liquid circulates before turning back to the opposite magnetic pole of the magnet from which it originated to complete the magnetic circuit. The spacing between adjacent magnets 20 prevents the field from short circuiting.

The oil filter canister 26 can be of any numerous types which are commonly used with internal combustion engines in conjunction with automobiles, air compressors, boats, trucks, robotics, generators, earth moving equipment and any other environment where an internal combustion engine will be used. Typically, the oil filter canister 26 is cylindrical, although not mandatory, and is normally made of ferrous material such as steel. The canister 26 wall thickness is typically between 0.014 to 0.018 inches thick for thin wall canisters and 0.028 to 0.032 inches for thicker wall canisters having higher gallons per minute flow therethrough. A filter element, not shown, is contained within the internal chamber 28 with this filter element being made of a porous fibrous material, generally of paper, that allows the liquid, normally oil, to pass through but is intended to trap particulate matter. The canister 26 has an end plate 30 which includes a central threaded hole 32. Attachment of the canister 26 to the internal combustion engine (not shown) is accomplished by the threaded hole 32 being threadably secured onto an appropriate threaded filter mount, which is not shown, which is located on the internal combustion engine. The lubricating oil is to be conducted into and out of the canister 26. The porous nature of the filter material contained within the internal chamber 28 is to permit the oil to seep through the filtering material while preventing the particulate matter entrained within the oil to be captured and held by the filtering material. The oil or liquid that exits the internal chamber 28 of the canister 26 is to be recirculated back into the engine. The structure and operation of the canister 26 is typical of most disposable canister type oil filters used in conjunction with internal combustion engines. The magnets 20, are to be made of a fully dense magnetic material, such as ceramic barium, strontium ferrite, metallic neodenium, iron boron or cerium cobalt. Each magnet 20 would preferably be a fully dense metallic alloy. Preferably, each magnet 20 has a radial thickness of about 0.25 inches, a circumferential width of about 0.125 inches and a longitudinal length of between 2 to 3 inches.

The magnets 20 are mounted within a plastic casing 34. The front wall 36 of the casing 34 constitutes the front surface of each attachment of this invention, such as the first embodiment 38 of attachment shown in FIG. 2. It is to be noted that the magnets 20 are shown mounted spaced from the casing 34 and the front wall 36. This spacing may or may not be necessary.

The magnetic field 40 that is thrown from the back side of the magnets 20 is confined and directed by a flux band which is composed of a plurality of ferrous plates 42 which are located in a stacked arrangement. Exteriorly of the flux band there is minimal magnetic field. It is to be noted that three in number of the plates 42 are utilized within the present invention. However, the number of the plates 42 could be increased or decreased without departing from the scope of this invention. By using of a plurality of the plates 42 instead of a solid piece of material, the attachment 38 is capable of expanding slightly which means that the attachment 38 can adapt to fit between a certain variance in diameters of canisters 26. For example, one size of the attachment 38 can be adapted to fit within one-half inch diameter variance of canisters 26. The plates 42 will typically vary in thickness from 0.15 to 0.25 inches in order to permit expanding or flexing of the attachment 38. However, the thickness size can be increased or decreased. The plates 42 will slide relative to each other. For a more detailed explanation of the plates 42, reference is to be had to the aforementioned patent application Ser. No. 09/817,467.

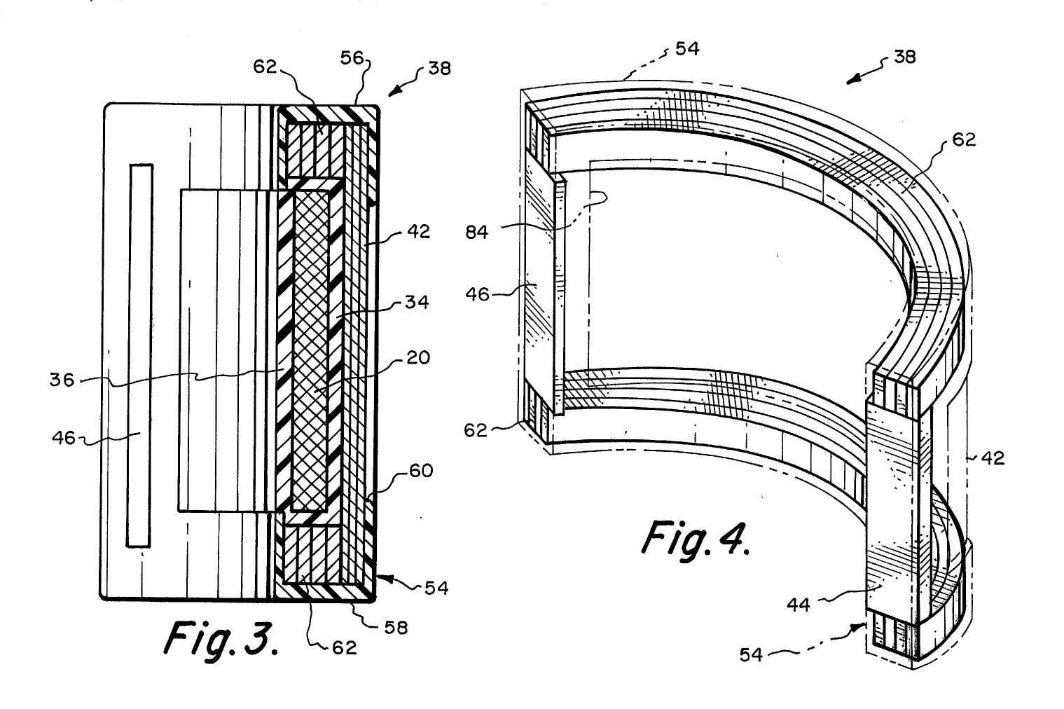

It is desirable to have the magnetic field 40 to be confined laterally. This lateral confinement is obtained by the utilizing of ferrous blocks 44 and 46 mounted within their respective side panels 48 and 50. The use of the blocks 44 and 46 is shown within the first embodiment 38 of attachment of this invention, shown in FIGS. 1 to 4. These blocks 44 and 46 keep the magnetic field 22 confined and prevents such from escaping laterally out through the side panels 48 and 50 of the housing 54. The blocks 44 and 46 could also be used in the embodiments to be described as the blocks 44 and 46 do not have to permit flexing of the attachment in the transverse direction.

The housing 54 will generally be constructed of injected molded plastic material and is designed to encase the casing 34, the plates 42, the blocks 44 and 46 and also the ferrous material that will be designed further on in this specification. The housing 54, besides having side edges 48 and 50, has a top edge 56 and a bottom edge 58. The housing 54 is cut out in the rear forming enlarged cut-out 60 which will expose the outermost plate of the plates 42. This outermost plate may be of non-ferrous material and will frequently have inscribed thereon the name of the product. It is necessary to have the magnetic field to be also confined and prevent escape from the top edge 56 and the bottom edge 58. This is to be achieved in the first embodiment of this invention, shown in FIGS. 1-4, by utilizing an arcuate series of ferrous strips 62. There is shown four in number of the strips 62 located within the top edge 56 and four in number of the ferrous strips located in the bottom edge 58. Again, the strips 62 will slide relative to one another during the flexing or expanding of the attachment 38. The number of the strips 62 could be increased or decreased. The thickness of the strips 62 could also vary according to the particular attachment.

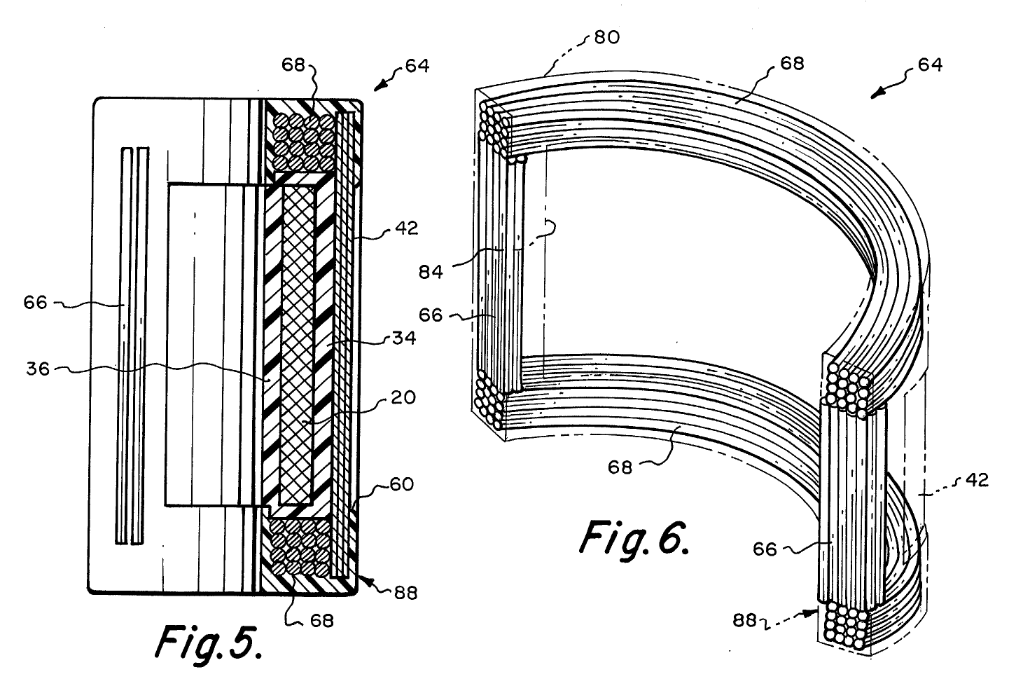

Referring particularly to FIGS. 5 and 6, there is shown the second embodiment 64 of attachment of this invention. Like numerals have been utilized to refer to like parts. The only difference in FIGS. 5 and 6 is that the blocks 44 and 46 are replaced by a series of assembled wires or rods 66 with an arcuate series of wires or rods 68 being substituted for the ferrous strips 62. Again, the use of the multiple members of the wire or rods 68 permits the attachment 64 to flex to accommodate to various sizes of oil filter canisters 26. When the attachment 64 expands, there will be a slight relative movement between the wires or rods 68. The wires or rods 66 may actually not be used but instead the blocks 44 and 46 could be used.

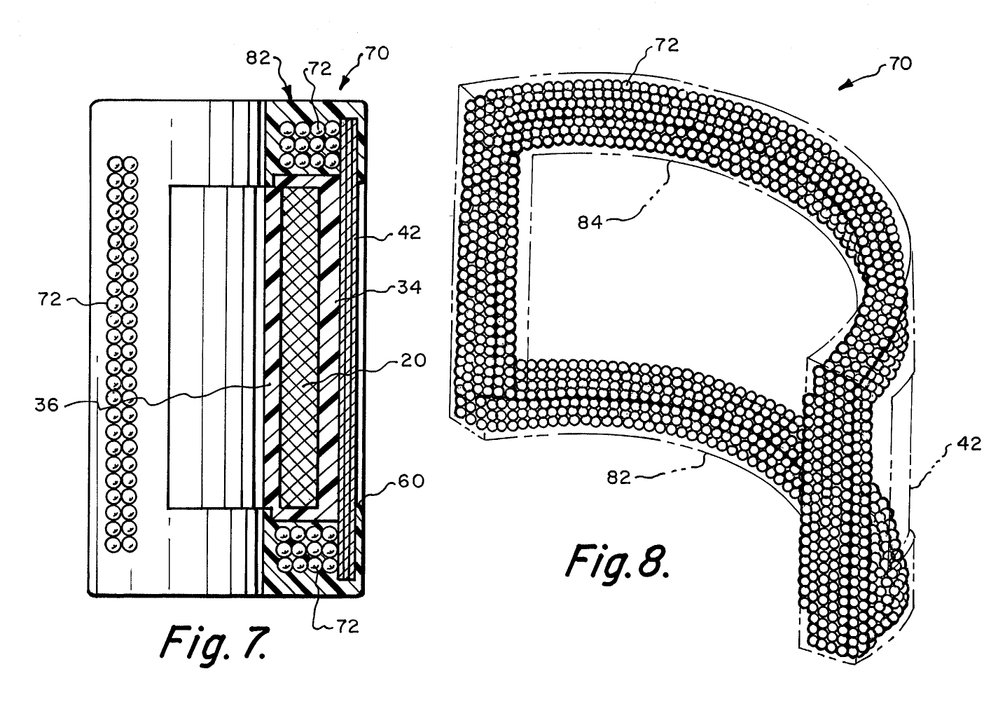

Referring particularly to FIGS. 7 and 8 of the drawings, there is shown a third embodiment 70 of attachment of this invention. Again, like numerals have been used to refer to like parts. However, instead of the rods 66 and 68 there is used shot 72. The shot 72 comprises a mass of ferrous balls. The peripheral side edge, composed of side panels 48 and 50, top edge 56 and bottom edge 58 which define the peripheral edge of the housing 54, may include a hollow chamber with the shot 72 to be merely poured therein filling that hollow chamber. Also, the shot 72 could actually be embedded within the plastic material of the peripheral edge.

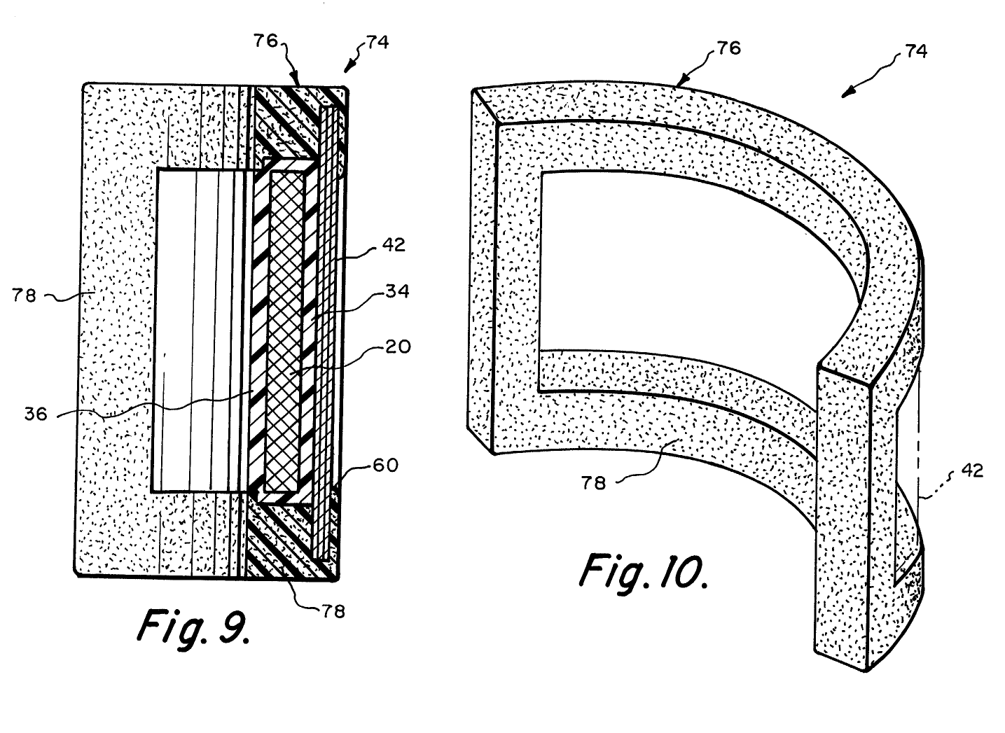

Referring particularly to FIGS. 9 and 10, there is shown a fourth embodiment 74 of attachment of this invention. The housing 76 of the fourth embodiment 74 is again constructed of an injection molded plastic material. Embedded within that plastic material is about forty percent of ferrous material 78. As a result, the housing 76 is again constructed to confine the magnetic field so that it is only emitted as magnetic field 22 from the attachment 74.

It is to be noted that each of the housing 54 in FIGS. 1-4, housing 80 in FIGS. 5 and 6, housing 82 in FIGS. 7 and 8 and housing 76 in FIGS. 9 and 10 have an enlarged center opening 84 within which is located the casing 34. The outside surface of the front wall 36 will be located flush with the front face of each of the housings and will actually intend to abut against the sidewall 24 of the canister 26. It is to be noted that the length of the plates 42 is such that they overlap the blocks 44 and 46, the wires or rods 68, the ferrous strip 62 and the shot 72 that is located within the side panels 48 and 50. The plates 42 also will cover the ferrous material that is contained within the top edge 56 and the bottom edge 58. In essence, the plates 42 combined with the ferrous material located in the side panels 48 and 50 and the top edge 56 and bottom edge 58 combine to form an enclosed ferrous container with the exception of the open front face through which the magnetic field 22 can escape.

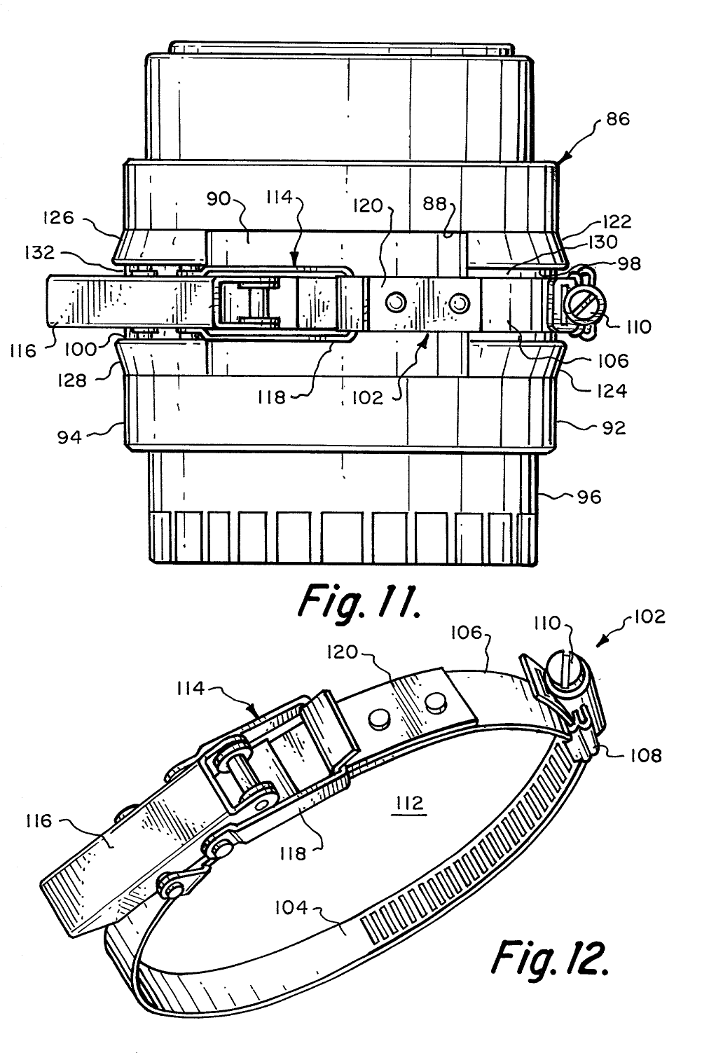

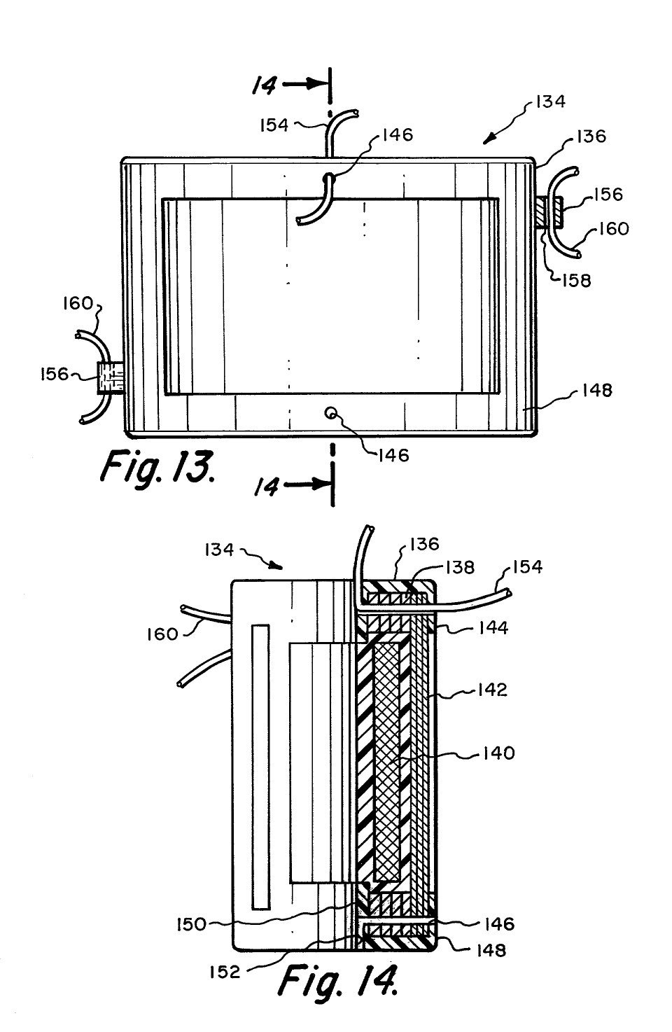

Referring particularly to FIGS. 11 and 12, there is shown a modified form of housing 86 for the magnetic filter attachment of this invention. The housing 86 could be used with any of the embodiments previously described. The housing 86 includes an enlarged center opening 88 which exposes a portion of a plate 90. The plate 90 could be of ferrous material or could be of non-ferrous material and would normally include some type of inscription, such as the name of the product. The housing 86 includes a right side edge 92 and a left side edge 94. It is to be understood that in between plates 90 and the oil filter canister 96 is a series of magnets, which are not shown. The right side edge 92 has centrally formed therein a groove 98. A similar groove 100 is formed in the left side edge 94. The grooves 98 and 100 are in alignment and function to locate or connect with a securing band 102. The securing band 102 is formed of a main strip 104 and a secondary strip 106. The strip 104 is connected to strip 106 at one end thereof by means of a pair of a guide rail members 108 with only one guide rail member 108 being shown. Mounted in conjunction with the guide rail members 108 is a worm gear screw 110. Moving of screw 110 produces relative movement between the main strip 104 and the secondary strip 106. The main strip 104 and the secondary strip 106 cooperate to define an enclosing area 112.

Fixedly mounted on the outer end of the main strip 104 is an over center buckle assembly 114. The buckle assembly 114 includes a handle 116 which connects to a frame 118. The frame 118 is connectable with a hook plate 120 which is fixedly mounted on the secondary strip 106. Moving of the handle 116 results in moving of the frame 118 between a lax position and a taught position.

The handle 116 is to be initially moved to a transverse position and the frame 118 disconnected from the hook plate 120. The securing band 102 is then placed within the grooves 98 and 100 with the canister 96 located within the enclosing area 112. The frame 118 is then placed in conjunction with the hook plate 120 and the handle 116 moved to a parallel position (substantially against the band 102), which is shown in FIG. 12 of the drawings. This will result in tightening of the securing band 102 forming a securement of the housing 86 to the canister 96. The screw 110 is to be initially turned so that when the handle 116 is moved to the transverse position eliminating the taught arrangement of the securing band 102, securing band 102 can then be merely lifted over the ridges 122 or 124 or 126 or 128 to be disengaged from the housing 86 and the canister 96 which will then permit the housing 86 to be disengaged from the canister 96 so that the canister 96 could be removed, discarded and replaced with a new canister 96. Once a new oil filter canister 96 is mounted on its appropriate mount, which is not shown, of the internal combustion engine, the housing 86 is to be installed in position and the securing band 102 again slipped over the ridges, such as ridges 124 and 128, locating such in conjunction with the grooves 98 and 100 and then the handle 116 is moved to the lower position, shown in FIG. 12, which securely binds the securing band 102 to both the housing 86 and the canister 96.

The securing band 102 has been found to be exceedingly useful in extreme vibration environments, such as in boats, racing vehicles, aircraft and off-road and military vehicle applications. Although there is shown only two grooves 98 and 100, it is considered to be within the scope of this invention that there could be utilized four different grooves with two securing bands 102 with each securing band 102 to connect with a pair of aligned grooves. A typical width of the main strip 104 and secondary strip 106, which are identical, would be about 0.5 inch. Typical thickness of the strips 104 and 106 would be about 0.040 inches. The bottom 130 of groove 98 and the bottom 132 of groove 100 are both raised about 0.040 inches above the surface of the plate 90. The reason for this is that when the securing band is installed in position and tightened that it will not come into contact with the plate 90 which may cause scaring the plate 90 and obliterating of any indicia imprinted thereon. The housing 86 is to include a textured surface 87 which is achieved during the injection molding process to provide a non-slip exterior surface which will facilitate the removing and reinstalling of the housing 86 on the canister 96, especially since the installer may have oil on his or her hands. The sidewalls of each of the ridges 122, 124, 126 and 128 that connect with their respective bottoms 130 and 132 are to be slightly tapered which will facilitate the locating procedure for the securing band 102.

Referring particularly to FIGS. 13 and 14, there is shown a modified embodiment 134 of attachment of this invention. The modified embodiment includes a peripheral side edge 136 of an injection molded plastic frame. Mounted within the peripheral side edge 136 are a stacked series of plates 138. Mounted within the attachment 134 are a series of magnets 140. The rear surface of the attachment 134 has a series of metallic plates 142 which will function as a flux band, which has been previously described. The metallic plates 142 are to be held in position in conjunction with the peripheral side edge 136 by an inwardly extending flange 144 which is integral with the peripheral side edge 136.

The peripheral side edge 136 may include a through hole 146. The through hole 146 connects between the rear surface 148 and the front surface 150. Formed within the front surface 150 is a groove 152. A tie down line 154 is to be conducted through the through hole 146 and through groove 152. The line 54 can comprise rope, wire or plastic and is to be wound about or otherwise secured to an exterior structure, which is not shown. This will provide a safety securement for the attachment 134 to eliminate the possibility of ever losing the attachment 134 during usage. For example, in an aircraft environment, a separate tie down would be required. The groove 152 is provided so that the line 154 does not interfere with the flush connection of the front surface 150 to the canister (not shown) on which it is mounted. The through hole 146 is conducted also through plates 138.

Instead of using through hole 146 there may be used instead a nub 156 that is integrally connected onto the peripheral side edge 136. There may be utilized more than one nub 156. Each nub 156 includes a through hole 158. A tie down line 160, which would be essentially similar to tie down line 154, is to be conductible through the through hole 158.

What is claimed is:

1. An assembly for an attachment to an exterior wall of a cylindrical filter canister through which a liquid is to pass comprising:
a housing having a front surface and a rear surface and a peripheral side edge;
a flux band constructed of a ferrous material, said flux band being mounted on said rear surface of said housing;
a plurality of magnets mounted directly adjacent said flux band, said magnets having a forward surface located directly adjacent said front surface adapted to be located directly adjacent the canister, whereby said magnets generate a magnetic force which creates a magnetic field within the canister which attracts and holds ferrous particles that are flowing within the liquid against the canister preventing such from exiting the canister by the flow of the liquid; and
said peripheral side edge including ferrous material, whereby said ferrous material functions to confine the magnetic field and direct such in an outward direction from said front surface.

2. The assembly as defined in claim 1 wherein:
each said magnet having a first side and a second side, said first side of each said magnet having a polarity opposite from said second side, each said side of a said magnet having a like polarity with a directly adjacent said side of a directly adjacent magnet.

3. The assembly as defined in claim 1 wherein:
each said magnet being spaced from a directly adjacent said magnet with said magnets being laid in a row.

4. The assembly as defined in claim 1 wherein:
said flux band being arcuate.

5. The assembly as defined in claim 1 wherein:
said flux band being constructed of a plurality of thin, metallic plates which are mounted in a stacked relationship.

6. The assembly as defined in claim 1 wherein:
said ferrous material comprising a plurality of metallic blocks.

7. The assembly as defined in claim 1 wherein:
said ferrous material comprising wires or rods.

8. The assembly as defined in claim 1 wherein:
said ferrous material comprising shot.

9. The assembly as defined in claim 1 wherein:
said ferrous material being impregnated within said housing.

10. The assembly as defined in claim 1 wherein:
said housing including a location groove, said location groove to connect with a separate securing band which is to function to fixedly mount said assembly onto the filter canister.

11. An assembly for an attachment to an exterior wall of a cylindrical filter canister through which a liquid is to pass comprising:
a housing, a magnet assembly mounted in conjunction with said housing, said housing including location means, a securing band being mounted in conjunction with said housing to secure said assembly to a filter canister, said securing means connecting with said location means in order to establish the position between said securing means and said housing.

12. The assembly as defined in claim 11 wherein:
said location means comprising at least one groove formed within said housing, said securing band to connect with said groove.

13. The assembly as defined in claim 11 wherein:
said securing band including an over center buckle assembly, said over center buckle assembly to be movable between a lax position and a taught position, locating of said over center buckle assembly in said lax position permits disengagement of said securing band from said housing, said taught position fixes said securing band on said housing.

14. The assembly as defined in claim 13 wherein:
said securing band including an adjusting screw, said adjusting screw being designed to establish the initial adjustment position of said securing band, said adjusting screw being spaced from said over center buckle assembly.

15. An assembly for attachment to an exterior wall of a filter canister through which liquid is to pass comprising:
a housing having a front surface and a rear surface and a peripheral edge;
a magnet assembly having a forward surface located in close proximity to said front surface and adapted to be located directly adjacent the canister, whereby said magnet assembly generates a magnetic force which creates a magnetic field within the canister which attracts and holds ferrous particles that are flowing within the liquid against the canister preventing such from exiting the canister by the flow of the liquid; and
said housing having a peripheral edge, said peripheral edge including ferrous material, whereby said ferrous material functioning to confine the magnet field and direct such in an outward direction from said front surface.

16. The assembly as defined in claim 15 wherein:
said magnet assembly being composed of a plurality of magnets located in a row with the poles of the magnet being arranged to buck one another.

17. The assembly as defined in claim 15 wherein:
said ferrous material comprising a mass of wires or rods that are mounted within said peripheral edge.

18. The assembly as defined in claim 15 wherein:
said ferrous material comprising shot that is mounted within said peripheral side edge.

19. The assembly as defined in claim 15 wherein:
said ferrous material comprising a mass of tiny particles which are impregnated within said peripheral edge.

20. The assembly as defined in claim 15 wherein:
said housing including location means, the location means facilitating connection with a securing band which is mounted about the housing and the canister which is to function to securely bind said assembly to the canister.

21. The assembly as defined in claim 20 wherein:
said location means comprising a groove.

22. An assembly for an attachment to an exterior wall of a cylindrical filter canister through which a liquid is to pass comprising:
a housing having a front surface and a rear surface, said front surface being connected to said rear surface by a peripheral side edge;
a plurality of magnets mounted in conjunction with said housing, said magnets having a forward surface located directly adjacent said front surface adapted to be placed directly adjacent said canister whereby said magnets generate a magnetic force which creates a magnetic field within the canister which attracts and holds ferrous particles that are flowing within the liquid against the canister preventing such from exiting the canister by the flow of the liquid; and
said rear surface and said peripheral side edge having a textured exterior surface to provide a non-slip surface facilitating manual grasping and manipulating of said housing relative to the cylindrical filter canister.

23. An assembly for an attachment to an exterior wall of a cylindrical filter canister through which a liquid is to pass comprising:
a housing having a front surface and a rear surface, said front surface being connected to said rear surface by a peripheral side edge;
a plurality of magnets mounted in conjunction with said housing, said magnets having a forward surface located directly adjacent said front surface adapted to be placed directly adjacent said canister whereby said magnets generate a magnetic force which creates a magnetic field within the canister which attracts and holds ferrous particles that are flowing within the liquid against the canister preventing such from exiting the canister by the flow of the liquid; and
said peripheral side edge having a through hole through which is to be conducted a tie down line, whereby said tie down line is to be used to provide a physical securement to an exterior structure.

24. The assembly as defined in claim 23 wherein:
said front surface including a groove, said groove connecting with said through hole, whereby said tie down member is to be located within said groove to not interfere with the flush mounting of said attachment onto the filter canister.

25. An assembly for an attachment to an exterior wall of a cylindrical filter canister through which a liquid is to pass comprising:
a housing having a front surface and a rear surface, said front surface being connected to said rear surface by a peripheral side edge;
a plurality of magnets mounted in conjunction with said housing, said magnets having a forward surface located directly adjacent said front surface adapted to be placed directly adjacent said canister whereby said magnets generate a magnetic force which creates a magnetic field within the canister which attracts and holds ferrous particles that are flowing within the liquid against the canister preventing such from exiting the canister by the flow of the liquid; and
said peripheral edge having a protruding nub, said nub having a through hole, a tie down line to be conducted through said through hole, whereby said tie down line is to be used to provide a physical securement to an exterior structure.
